(19) United States
(12) Patent Application Publication
(10) Pub. No.: US 2010/0000212 A1
(43) Pub. Date: Jan. 7, 2010

(54) Pulley system powered by loss of buoyancy

(76) Inventor: Carl Richard Snyder, Pembroke Pines, FL (US)

Correspondence Address: CARL R. SNYDER, 2 ST, 19420 SW, PEMBROKE PINES, FL, 33029, US

(21) Appl. No.: 12/217,382

(22) Filed: Jul. 3, 2008

(51) Int. Cl. F03B 17/00

(52) U.S. Cl. 60/496

(57) ABSTRACT

The Pulley System Powered by Loss of Buoyancy is a design to configure a buoyant vessel, a pulley, and a counter-weight such that they form a system that can produce a positive work output that can be used to drive gears. The core idea of this design is the use of loss of buoyancy as a power source.

The Pulley System Powered by Loss of Buoyancy is a system that can drive gears using loss of buoyancy as the source of power. Industry standard aluminum alloy or carbon fiber composite materials can be used to construct the system.

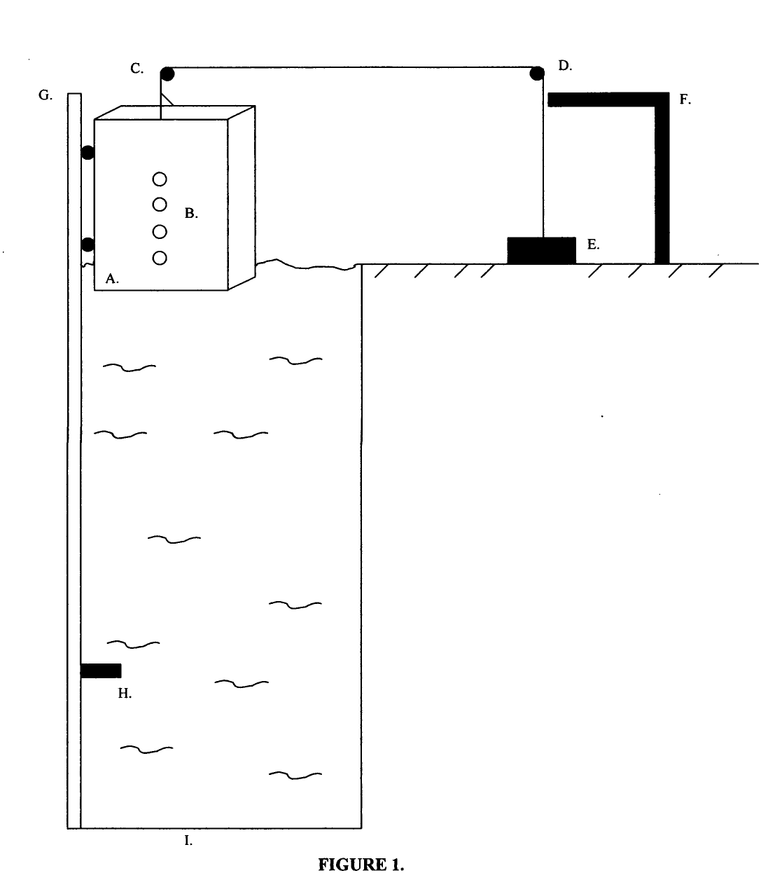

(Refer to FIG. 1.) Vessel A has a floor, 4 walls, and an open top. The vessel is constructed of aluminum alloy or carbon fiber composite material. The vessel is initially buoyant and is placed in a lake, reservoir, or tank with adequate water supply. Vessel A is attached to a counter-weight E via cable that runs through pulleys C and D. Vessel A is also attached via wheels K to rail track G. Electronically activated valves B open and cause Vessel A to be flooded with water. As vessel A sinks, it pulls up counter-weight E and drives pulleys C and D. Vessel A eventually sinks to stop H and the movement of counter-weight E upwards is limited by stop F. Rail track G keeps vessel A aligned vertically as it sinks and rises. Gears can be linked to pulley D and driven during the sinking of vessel A.

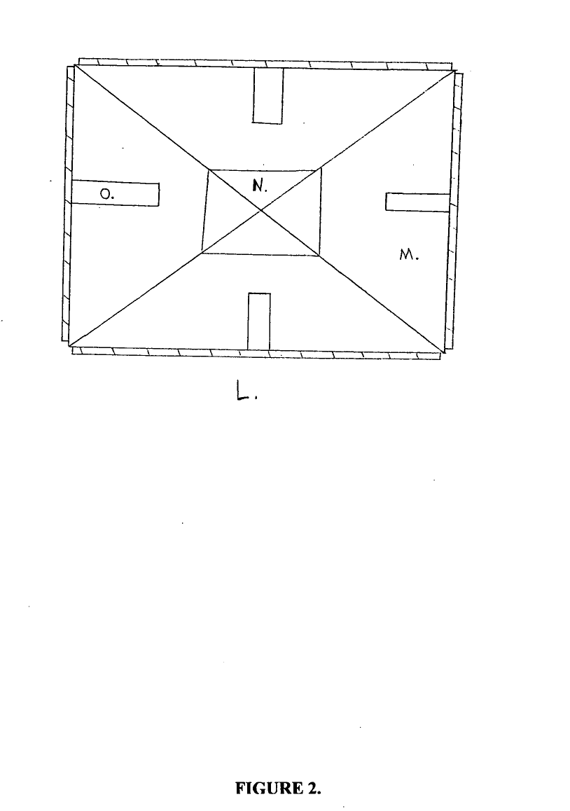

(Refer to FIG. 2.) The floor of Vessel A is shown in FIG. 2. The floor is divided into 4 sections. Each floor section is connected to its nearest vessel wall via a hinge (L). The portion of each floor section nearest to the hinge (M) is buoyant and lightweight. The portion of each floor section nearest to the center of the floor (N) is 5 times heavier than the rest of the floor section. Electronically controlled latches in the floor release the floor sections at the center once vessel A has sunk and its sinking has been stopped by stop H. The floor sections then swing out and down, with the heavier part of each section (N) sinking down into the water and allowing the floor sections to swing all the way out and down. After that occurs, the vessel can be lifted back up by counter-weight E. When the vessel is mostly out of the water, electrical motors and lifts (O) swing the floor sections back into place and the electrical latches in the floor lock the sections back together. Electronically activated valves B close as the floor sections are lifted back up. The process for sinking the vessel and driving the pulleys can start again.

The system produces positive work output that can be used to drive gears attached to pulley D. Externally provided electrical power is needed to drive the electronically controlled valves, electronically controlled floor latches, and electronic floor section lifts.

### INTRODUCTION

The Pulley System Powered by Loss of Buoyancy is a design to configure a buoyant vessel, a pulley, and a counter-weight such that they form a system that can produce a positive work output that can be used to drive gears. Inventor is Mr. Carl R. Snyder, 19420 SW 2 St, Pembroke Pines, Fla. 33029.

### BACKGROUND

This invention uses principles primarily from the fields of mechanical engineering, physics, and materials engineering. Purpose of the invention is to solve the problem of driving gears and produce a positive work output without using combustion of fuel.

### DESCRIPTION OF FIG. 1

Vessel A has a floor, 4 walls, and an open top. The vessel is constructed of aluminum alloy or carbon fiber composite material. The vessel is initially buoyant and is placed in a lake, reservoir, or tank with adequate water supply. Vessel A is attached to a counter-weight E via cable that runs through pulleys C and D. Vessel A is also attached via wheels K to rail track G. Electronically activated valves B open and cause Vessel A to be flooded with water. As vessel A sinks, it pulls up counter-weight E and drives pulleys C and D. Vessel A eventually sinks to stop H and the movement of counter-weight E upwards is limited by stop F.

### DESCRIPTION OF FIG. 2

The floor of Vessel A is shown in FIG. 2. The floor is divided into 4 sections. Each floor section is connected to its nearest vessel wall via a hinge (L). The portion of each floor section nearest to the hinge (M) is buoyant and lightweight. The portion of each floor section nearest to the center of the floor (N) is 5 times heavier than the rest of the floor section. Electronically controlled latches in the floor release the floor sections at the center. The floor sections then swing out and down, with the heavier part of each section (N) sinking down into the water and allowing the floor sections to swing all the way out and down. After that occurs, the vessel can be lifted back up by counter-weight E. When the vessel is mostly out of the water, electrical motors and lifts (O) swing the floor sections back into place and the electrical latches in the floor lock the sections back together. Electronically activated valves B close as the floor sections are lifted back up. The process for sinking the vessel and driving the pulleys can start again.

### DETAILED DESCRIPTION

The Pulley System Powered by Loss of Buoyancy is a system that can drive gears using loss of buoyancy as the source of power. Industry standard aluminum alloy or carbon fiber composite materials can be used to construct the system.

(Refer to FIG. 1.) Vessel A has a floor, 4 walls, and an open top. The vessel is constructed of aluminum alloy or carbon fiber composite material. The vessel is initially buoyant and is placed in a lake, reservoir, or tank with adequate water supply. Vessel A is attached to a counter-weight E via cable that runs through pulleys C and D. Vessel A is also attached via wheels K to rail track G. Electronically activated valves B open and cause Vessel A to be flooded with water. As vessel A sinks, it pulls up counter-weight E and drives pulleys C and D. Vessel A eventually sinks to stop H and the movement of counter-weight E upwards is limited by stop F. Rail track G keeps vessel A aligned vertically as it sinks and rises. Gears can be linked to pulley D and driven during the sinking of vessel A.

(Refer to FIG. 2.) The floor of Vessel A is shown in FIG. 2. The floor is divided into 4 sections. Each floor section is connected to its nearest vessel wall via a hinge (L). The portion of each floor section nearest to the hinge (M) is buoyant and lightweight. The portion of each floor section nearest to the center of the floor (N) is 5 times heavier than the rest of the floor section. Electronically controlled latches in the floor release the floor sections at the center once vessel A has sunk and its sinking has been stopped by stop H. The floor sections then swing out and down, with the heavier part of each section (N) sinking down into the water and allowing the floor sections to swing all the way out and down. After that occurs, the vessel can be lifted back up by counter-weight E. When the vessel is mostly out of the water, electrical motors and lifts (O) swing the floor sections back into place and the electrical latches in the floor lock the sections back together. Electronically activated valves B close as the floor sections are lifted back up. The process for sinking the vessel and driving the pulleys can start again.

The system produces positive work output that can be used to drive gears attached to pulley D. Externally provided electrical power is needed to drive the electronically controlled valves, electronically controlled floor latches, and electronic floor section lifts.

1. This patent is to secure rights to the design of this system that includes the combined use of a vessel, a pulley, and a counter-weight to produce positive work output via the vessel's loss of buoyancy. Any variation of vessel shape designed, liquid used, or combination of pulleys employed to make use of the loss of buoyancy as a power source should be protected by this patent. The core idea of this design is the specific concept of using a vessel's loss of buoyancy to produce a system that can drive gears.

2. A system that produces a positive work output through a loss of buoyancy, comprising:
(a) A buoyant vessel with a four-section floor, 4 side walls, and an open top.
(b) Two pulleys.
(c) A counterweight supported by one of the pulleys.
(d) Electronically controlled valves attached to the side walls of the vessel.
(e) Electronically controlled latches connected to each floor section.
(f) Electronically controlled lifts attached to each floor section.
